(19) United States
(12) Patent Application Publication
(10) Pub. No.: US 2016/0012561 A1
(43) Pub. Date: Jan. 14, 2016

(54) Systems and Methods for Detecting Identity Theft of a Dependent

(71) Applicant: LexisNexis Risk Solutions FL Inc., Boca Raton, FL (US)

(72) Inventors: Steven Lappenbusch, Beaverton, OR (US); Samantha Gwinn, Washington, DC (US); Cindy Loizzo, Boca Raton, FL (US); Monty Faidley, Kennesaw, GA (US); Bill Haas, Pompano Beach, FL (US); Karen Robinson, Wellington, FL (US)

(73) Assignee: LEXISNEXIS RISK SOLUTIONS FL INC.

(21) Appl. No.: 14/794,899

(22) Filed: Jul. 9, 2015

Related U.S. Application Data
(60) Provisional application No. 62/023,077, filed on Jul. 10, 2014.

(51) Int. Cl. G06Q 50/26; G06Q 50/16; G06Q 40/00; G06F 17/30; G06Q 40/02

(52) U.S. Cl. CPC G06Q 50/265; G06F 17/30554; G06Q 40/025; G06Q 40/123; G06Q 50/16

(57) ABSTRACT

Certain embodiments of the disclosed technology may be utilized for determining a likelihood of dependent identity misrepresentation, theft, and/or fraud. In an example method, one or more dependent-related records may be received from one or more public, private, and/or governmental sources or databases. The method may include querying one or more public or private databases with at least a portion of personally identifiable information (PII) from the received dependent-related records. The method may include receiving a plurality of independent information in response to the querying. The method can include determining an indication of one or more matching records. The method can include determining one or more indicators of dependent identity fraud, and outputting, for display, the one or more indicators of fraud.

### RELATED APPLICATIONS

This application claims priority to U.S. Provisional Application No. 62/023,077, filed 10 Jul. 2014, the contents of which are incorporated herein as if presented in full.

### FIELD

The disclosed technology generally relates to detecting identity theft, and in particular, to systems and methods for detecting identity theft associated with a dependent.

### BACKGROUND

Businesses and governmental agencies face a number of growing problems associated with identity theft-based fraud. For example, fraudsters can apply for credit, payments, benefits, tax refunds, etc. by misrepresenting their identity. Identity theft can take several forms, including stealing and using identity information from another adult, a child, or even a deceased person. The associated revenue loss to the businesses and/or government agencies can be significant, and the technical and emotional burden on the victim to rectify their public, private, and credit records can be onerous.

Identity theft can occur when a person's identity is used by another person for personal gain. In certain cases, the perpetrator may be a family member or someone known by the family. In other cases, the perpetrator may be a stranger who purposely targets dependents and/or children because of the often lengthy time between the fraudulent use of the dependent's/child's information and the discovery of the crime. Typically, identity theft occurs when personally identifying information (such as a social security number) used to establish a new line of credit. In some instances, credit issuers may not actually verify the age or related information of the applicant, and once the fraudulent credit line is established, the represented applicant information can remain associated with the account(s) and/or the various credit reporting agencies until a dispute is filed and proven otherwise.

Technically well-informed fraud perpetrators with sophisticated deception schemes are likely to continue targeting dependents for identity theft, particularly if fraud detection and prevention mechanisms are not in place.

### BRIEF SUMMARY

Some or all of the above needs may be addressed by certain embodiments of the disclosed technology. Certain embodiments of the disclosed technology may include systems and methods for detecting dependent-related identity theft and/or fraud associated with the identity theft.

According to an example embodiment of the disclosed technology, a method is provided for determining a likelihood of dependent-identity misrepresentation, theft, and/or fraud. In an example implementation, the method can include receiving, from one or more sources, dependent-related records. In an example implementation, the method may include querying one or more public and/or private databases with at least a portion of personally identifiable information (PII) from the received dependent-related records, for example, to find other records that are associated with the PII. The method may include receiving a plurality of independent information in response to the querying. The method can include determining, with a special-purpose computer having one or more computer processors in communication with a memory, based at least in part on a comparison of the PII with at least a portion of the plurality of independent information, an indication of one or more matching records. The method can include determining, with the special-purpose computer, and based at least in part on the indication of the one or more matching records, one or more indicators of dependent identity fraud. The method can also include outputting, for display, the one or more indicators of dependent identity fraud.

According to another example embodiment of the disclosed technology, a system is provided for determining a likelihood of dependent-identity misrepresentation, theft, and/or fraud. The system can include a special-purpose computer, comprising at least one memory for storing data and computer-executable instructions, and at least one processor configured to access the at least one memory and further configured to execute the computer-executable instructions to: receive, from one or more sources, one or more dependent-related records; query one or more public or private databases with at least a portion of personally identifiable information (PII) from the received dependent-related records; receive a plurality of independent information in response to the querying; determine, based at least in part on a comparison of the PII with at least a portion of the plurality of independent information, an indication of one or more matching records; determine, based at least in part on the indication of the one or more matching records, one or more indicators of dependent identity fraud; and output, for display, the one or more indicators of the dependent identity fraud

Other embodiments, features, and aspects of the disclosed technology are described in detail herein and are considered a part of the claimed disclosed technologies. Other embodiments, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of an illustrative scenario associated with dependent identity theft, according to exemplary embodiments of the disclosed technology.

FIG. 2 is a block diagram of an illustrative fraud detection system 200 according to an exemplary embodiment of the disclosed technology.

FIG. 3 is a block diagram of an illustrative fraud detection system architecture 300 according to an exemplary embodiment of the disclosed technology.

FIG. 4 is a flow diagram of a method 400 according to an exemplary embodiment of the disclosed technology.

FIG. 5 is a flow diagram of a method 500 according to an exemplary embodiment of the disclosed technology.

FIG. 6 is a flow diagram of a process 600 according to an exemplary embodiment of the disclosed technology.

FIG. 7 is a flow diagram of a method 700 according to an exemplary embodiment of the disclosed technology.

### DETAILED DESCRIPTION

Embodiments of the disclosed technology will be described more fully hereinafter with reference to the accompanying drawings, in which embodiments of the disclosed technology are shown. This disclosed technology may, however, be embodied in many different forms and should not be construed as limited to the embodiments set forth herein; rather, these embodiments are provided so that this disclosure will be thorough and complete, and will fully convey the scope of the disclosed technology to those skilled in the art.

In the following description, numerous specific details are set forth. However, it is to be understood that embodiments of the disclosed technology may be practiced without these specific details. In other instances, well-known methods, structures and techniques have not been shown in detail in order not to obscure an understanding of this description. The term “exemplary” herein is used synonymous with the term “example” and is not meant to indicate excellent or best. References to “one embodiment,” “an embodiment,” “exemplary embodiment,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

As used herein, the term “dependent” may generally be defined as a person who may be claimed as a dependent on another person's tax return. For example, a taxpayer cannot claim a dependency tax exemption for a person who can be claimed as a dependent on another tax return. In certain instances, the term “dependent” may mean a “qualifying child,” who may be a person under the age of 18 and/or may be designated as being dependent on a parent for tax purposes. In other instances, the term “dependent” may refer to a “qualifying relative” or other person who may be an adult, but who may nevertheless be designated as dependent for tax purposes.

According to certain example implementations of the disclosed technology, certain anomalous or fraudulent activity may be detected. In one example implementation, matching or partially-matching records may be utilized to provide indicators of anomalous or fraudulent activity with regard to possible identity theft of a dependent. For example, certain personally identifiable information (PII) data (i.e., name, address, social security number, etc.) may be associated with certain corresponding individuals. However, the disambiguation, comparison, and analysis of the data may require special-purpose computing systems and custom query language due to the sheer amount of data that needs to be tracked, compared, and analyzed to provide meaningful results.

Certain example implementations of the disclosed technology provide tangible improvements in computer processing speeds, memory utilization, and/or programming languages. Such improvements provide certain technical contributions that can enable the detection of anomalous activity associated with dependent-related identity theft. In certain example implementations, the improved computer systems disclosed herein may enable analysis and processing of data for an entire population, such as the United States. The computation of such a massive amount of data, at the scale required to provide effective information, has been enabled by the improvements in computer processing speeds, memory utilization, and/or programming language as disclosed herein. Those with ordinary skill in the art may recognize that traditional methods such as human activity, pen-and-paper analysis, or even traditional computation using general-purpose computers, are not sufficient to provide the required level of data processing and dependent-related identity theft detection needed. The special-purpose computer, special-purpose programming language, and improved computer speed and memory utilization, as disclosed herein, may at least partially enable the utility of the disclosed technology.

Certain example implementations of the disclosed technology may be enabled by the use of a new programming language known as KEL (Knowledge Engineering Language). Certain embodiments of the KEL programming language may be configured to operate on the specialized HPCC Systems, as developed and offered by LexisNexis Risk Solutions, Inc., the assignee of the disclosed technology. HPCC Systems provides a data-intensive supercomputing platform designed for solving big data problems. As an alternative to Hadoop, the HPCC Platform offers a consistent, single architecture for efficient processing. The KEL programming language, in conjunction with the HPCC Systems, provides technical improvements in computer processing that enable the disclosed technology and provides useful, tangible results that may have previously been unattainable.

According to an example embodiment of the disclosed technology, a method is provided for determining a likelihood of dependent identity misrepresentation, theft, and/or fraud. In an example implementation, one or more dependent-related records may be received from one or more public, private, and/or governmental sources or databases. The received dependent-related information may indicate that a particular individual is (or has been) represented as a dependent. For example, certain governmental records, such as those associated with tax return documents, may be utilized to independently identify an entity as a dependent of a taxpayer. In another example implementation, foster and/or health care records may be utilized to associate personally identifiable information (PII) with a particular dependent.

Rather than rely solely on storing and analyzing dependent PII data, certain example implementations of the disclosed technology may receive records that have been declared (for example, by governmental entities) as related to a dependent. In an example implementation, the PII data (for example, a social security number) from these records may then be utilized to search for records in one or more public and/or private databases to find records of other entities that have matching or partial matching PII's. In certain implementations, the matching records may then be analyzed for activity that would not necessarily be associated with activities of a dependent. For example, matching public records may indicate that a dependent's identity is being used buy real property, obtain credit, etc., and according to certain example implementations, these records may be flagged as being possibly related to fraudulent activity.

In another example implementation, records that are associated with adults (e.g. adult tax filers or foster parents) may be analyzed in a similar fashion as described above with respect to the dependent-related records, to determine if those adults are using a PII that has been identified or declared as PII of a dependent person.

Currently, governmental agencies may be unable to find misuse of dependent identities due to lack of access to vital records listing dependent identities. Certain example implementations of the disclosed technology may be utilized by government agencies, for example, to detect and prevent further dependent identity theft for persons in their jurisdiction. For example, various implementations of the disclosed technology may solve the problem of dependent identity theft and fraud in a “backwards” fashion. In other words, in certain example implementations of the disclosed technology, it may not be necessary to have access to a database of dependent identities. The lack of access to records listing dependent identities has been an impediment to previous attempts to solve this issue by others. However, implementations of the disclosed technology may be used to determine which input identities are claimed as dependents from available records. Then based on the PII from these dependent-related records, public and/or private database records may be searched to determine who else is using those identities. If those identities are sufficiently compromised (e.g. 10 people using the SSN of an input marked as a dependent) then that dependent record may be flagged as compromised. Certain example implementations may search through public records to determine where and by whom that identity is being used. In so doing, indications may be determined with respect to who is stealing the dependent's identity, where the identity theft is being used, and for what purposes—without necessarily relying on data from the dependent person.

Certain example embodiments of the disclosed technology may utilize a model to build a profile of indicators of fraud that may be based on multiple variables. In certain example implementations of the disclosed technology, the interaction of the indicators and variables may be utilized to produce one or more scores indicating the likelihood or probability of fraud associated with dependent identity theft.

According to an example implementation, input information from a determined dependent record may include personally identifiable information (PII) such as a name, a street address, and/or a social security number. This PII input information may be utilized as input to find related information in one or more public or private databases in order to find matching records, for example, that match or partially match some of the PII information. Example embodiments of the disclosed technology may be utilized to score indicators of dependent-related identity fraud.

For example, in one aspect, addresses associated with a dependent entity and their closest relatives or associates may be analyzed to determine distances between the addresses. For example, the greater distance may indicate a higher the likelihood of fraud because, for example, a fraudster may conspire with a relative or associate in another city, and may assume that their distance may buffer them from detection.

Certain example embodiments of the disclosed technology may utilize profile information related to a dependent entity's neighborhood. For example, information such as density of housing (single family homes, versus apartments and condos), the presence of businesses, and the median income of the neighborhood may correlate with a likelihood of fraud. For example, entities living in affluent neighborhoods are less likely to be involved with fraud, whereas dense communities with lower incomes and lower presence of businesses may be more likely to be associated with fraud.

Embodiments of the disclosed technology may be used to appraise the validity of the input identity elements, such as the name, street address, social security number (SSN), phone number, date of birth (DOB), etc., to verify whether or not requesting entity input information corresponds to a real identity. Certain example implementations may utilize a correlation between the input SSN and the input address, for example, to determine how many times the input SSN has been associated with the input address via various sources. Typically, the lower the number, then the higher the probability of fraud.

Certain example implementations of the disclosed technology may be used to determine the number of unique SSNs associated with the input address. Such information may be helpful in detecting dependent identity theft-related fraud, and may also be helpful in finding fraud rings because, for example, the fraudsters may have created synthetic identities, but they may request that all payments be sent to one address.

Certain example implementations may be used to determine the number of SSNs associated with the dependent identity or PII in one or more public or private databases. For example, if the SSN has been associated with multiple identities, then it is likely a compromised SSN and the likelihood of fraud may be high.

According to an example implementation, the disclosed technology may be utilized to verify the validity of the input address. For example, if the input address has never been seen in public records, then it is probably a fake address and the likelihood of fraud may be high.

Certain example implementations of the disclosed technology may be utilized to determine if the input PII data corresponds to a deceased person, a currently incarcerated person, a person having prior incarceration (and time since their incarceration), and/or whether the person has been involved in bankruptcy. For example, someone involved in a bankruptcy may be less likely to be a fraudster.

Certain embodiments of the disclosed technology may enable the detection of possible, probable, and/or actual dependent identity theft-related fraud, for example, as associated with a request for credit, payment, or a benefit. Certain example implementations may provide for disambiguating input information and determining a likelihood of fraud. In certain example implementations, the input information may be received from a requesting entity in relation to a request for credit, payment, or benefit. In certain example implementations, the input information may be received from a requesting entity in relation to a request for an activity from a governmental agency.

In accordance with an example implementation of the disclosed technology, input information associated with a requesting entity may be processed, weighted, scored, etc., for example, to disambiguate the information. Certain implementations, for example, may utilize one or more input data fields to verify or correct other input data fields.

In a exemplary embodiment, a request for an activity may be received. For example, the request may be for a tax refund. In one example embodiment, the request may include a requesting person's name, street address, and social security number (SSN), where the SSN has a typographical error (intentional or unintentional). In this example, one or more public or private databases may be searched to find reference records matching the input information. But since the input SSN is wrong, a reference record may be returned matching the PII name and street address, but with a different associated SSN. According to certain example implementations, the PII input information may be flagged, weighted, scored, and/or corrected based on one or more factors or attributes, including but not limited to: fields in the reference record(s) having field values that identically match, partially match, mismatch, etc, the corresponding PII field values.

Example embodiments of the disclosed technology may reduce false positives and increase the probability of identifying and stopping fraud based on a customized dependent identity theft-based fraud score. According to an example implementation of the disclosed technology, a model may be utilized to process identity-related input information against reference information (for example, as obtained from one or more public or private databases) to determine whether the input identity being presented corresponds to a real identity, to the correct identity, and/or to a possibly fraudulent identity.

Certain example implementations of the disclosed technology may be utilized to determine or estimate a probability of dependent identity theft-based fraud based upon a set of parameters. In an example implementation, the parameters may be utilized to examine the input data, such as name, address and social security number, for example, to determine if such data corresponds to a real identity. In an example implementation, the input data may be compared with the reference data, for example, to determine field value matches, mismatches, weighting, etc. In certain example implementations of the disclosed technology, the input data (or associated entity record) may be scored to indicate the probability that it corresponds to a real identity.

In some cases, a model may be utilized to score the input identity elements, for example, to look for imperfections in the input data. For example, if the input data is scored to have a sufficiently high probability that it corresponds to a real identity, even though there may be certain imperfections in the input or reference data, once these imperfections are found, the process may disambiguate the data. For example, in one implementation, the disambiguation may be utilized to determine how many other identities are associated with the input SSN. According to an example implementation, a control for relatives may be utilized to minimize the number of similar records, for example, as may be due to Jr. and Sr. designations.

In an example implementation, the input PII data may be utilized to derive a date-of-birth, for example, based on matching reference records. In one example implementation, the derived date-of-birth may be compared with the issue date of the SSN. If the dates of the SSN are before the DOB, then the flag may be appended for this record as indication of fraud.

Another indication of fraud that may be determined, according to an example implementation, includes whether the entity has previously been associated with a different SSN. In an example implementation, a “most accurate” SSN for the entity may be checked to determine whether the entity is a prisoner, and if so the record may be flagged. In an example implementation, the input data may be checked against a deceased database to determine whether the entity has been deceased for more than one or two years, which may be another indicator of fraud.

### Scoring:

In accordance with certain example embodiments of the disclosed technology, a score may be produced to represent how closely input data matches with the reference data. As discussed above, the input data may correspond to the entity supplied information associated with a request for a benefit or payment. The reference data, according to an example implementation, may be one or more records, each record including one or more fields having field values, and derived from one or more public or private databases. In certain example implementations, the reference data may be the best data available, in that it may represent the most accurate data in the databases. For example, according to one implementation, the reference data may be cross verified among various databases, and the various records and/or fields may be scored with a validity score to indicate the degree of validity.

In certain example implementations of the disclosed technology, the scores that represent how closely input data matches with the reference data scores may range from 0 to 100, with 0 being worst and 100 being best. In other example implementations, a score of 255 may indicate a null value for the score, for example, to indicate that it is not a valid score and should not be read as indicating anything about the goodness of the match.

According to an example implementation, two types of scores may be utilized: hard scores and fuzzy scores, as known by those of skill in the art. Fuzzy scores, for example are dependent on multiple factors and the same score may mean different things.

In accordance with an example implementation, certain scores may be common across all types of verification scores. For example, a “0” may represent a very poor match, or a total mismatch, while a “100” may represent a perfect match. According to an example implementation a “255” may indicate a null (or invalid) comparison. In some cases, such a null designation may be due to missing data, either in the input data or in the reference data. For example, a null in the address score may indicate certain types of invalid addresses or missing information, while a “100” may represent a perfect match across primary and secondary address elements.

In certain example implementations of the disclosed technology, a score in the range of “1-90” may be representative of a fuzzy range of scores that mean primary elements of the address disagree in ways ranging from serious to minor. In certain implementations, higher scores may be better, with 80 or higher generally considered a “good match,” and lower scores increasingly less similar, and with “0” representing a total mismatch.

According to an example implementation other scores may be dependent on the type of matching being done. For example, with regard to the phone number, a “255” may represent a blank input phone number, a blank reference phone number, or both being blank. In an example implementation, a “100” may indicate that the last 7 digits of the input and reference phone numbers are an exact match, while a “0” may represent any other condition.

With regard to the SSN, and according to an example implementation a “255” may represent a blank input SSN, a blank reference SSN, or both being blank. In an example implementation, if neither of the SSNs (input or reference) are blank, then a computed score may be determined as 100 minus a ‘similarity score’. For example, the computed scored may result in a perfect match of “100” if ‘similarity score’ is 0, and generally speaking, a very close match may result in a computed score of 80 or 90, while a 70 may be considered a possible match.

According to an example implementation, an entity's date of birth (DOB) may be scored by comparing the input data with reference data. In one example implementation the standard format for dates may be represented by a year, month, day format (yyyymmdd). In certain example implementations of the disclosed technology, null values may be referenced or identified by scores of 00 or 01. In an example implementation, a “255” may represent invalid or missing DOB data in the input data, the reference data, or both while a “100” may represent a perfect yyyymmdd match. According to an example implementation, “80” may represent that yyyymm are the same and the day data (dd) is null in the input data, the reference data, or both. According to an example implementation, “60” may represent that yyyymm are the same, but the days are different in the input an reference data, but not null. According to an example implementation, “40” may represent that yyyy are the same, but mmdd in the input data, the reference data, or both is null. According to an example implementation, a “20” may represent that yyyy are the same, but the in the input data the reference data differ by month and day. Finally a “0” score may represent that there is no match between in the input DOB data and the reference DOB data.

With regard to the name, a “255” may represent a blank input name, a blank reference name, or both being blank, or no first, middle, or last name. Otherwise, the score may be computed similarly to SSN. For example, a name match algorithm may be applied to the input and reference names, and the various qualities of matches may range from a perfect match (with a verify score of 100) to a poor match (with a verify score of 50) to no match (with a score of 0).

### Scoring Examples

In accordance with an example implementation, a name scoring may be utilized to determine how close the input names (first, middle and last) match to the reference name.

| Input Name | Best Name | Score | |
|---|---|---|---|
| ‘RICHARD L TAYLOR’, | ‘RICHARD L TAYLOR’ | 100 | |
| ‘RICH L TAYLOR’, | ‘RICHARD L TAYLOR’ | 90 | |
| ‘RICH TAYLOR’, | ‘RICHARD L TAYLOR’ | 80 | |
| ‘ROD L TAYLOR’, | ‘RICHARD L TAYLOR’ | 0, | (believed to |
| | | | be another |
| | | | person). |

In an example implementation, the SSN score may be used to determine how similar the input SSN is to the reference SSN.

| Input SSN | Reference SSN | Score |
|---|---|---|
| ‘ABCDEFGHI’, | ‘ABCDEFGHI’, | 100 |
| ‘ABCDEFGHZ’, | ‘ABCDEFGHI’, | 90 |
| ‘ABCDEFGZZ’, | ‘ABCDEFGHI’, | 80 |
| ‘ABCDEFZZZ’, | ‘ABCDEFGHI’, | 70 |
| ‘ABCDEZZZZ’, | ‘ABCDEFGHI’, | 60 |
| ‘ABCDZZZZZ’, | ‘ABCDEFGHI’, | 40 |
| ‘ZZZZZFGHI’, | ‘ABCDEFGHI’, | 40 |

Certain embodiments of the disclosed technology may enable the detection of possible, probable, and/or actual fraud associated with a request for a payment or a benefit to a governmental agency. Embodiments disclosed herein may provide systems and methods for detecting identity misrepresentation, identity creation or identity usurpation related to the request. According to an example implementation of the disclosed technology, PII input information, together with information obtained from other sources, such as public or private databases, may be utilized to determine if the PII and related activity is likely to be fraudulent or legitimate.

Certain embodiments of the disclosed technology may enable detection of various requests for payment, benefit, service, refund, etc. from a government agency or entity. The government agency, as referred to herein, may include any government entity or jurisdiction, including but not limited to federal, state, district, county, city, etc. Embodiments of the disclosed technology may be utilized to detect fraud associated with non-government entities. For example, embodiments of the disclosed technology may be utilized by various businesses, corporations, non-profits, etc., to detect fraud.

Due to the development of the Internet, technically well-informed fraudsters with sophisticated deception schemes are likely to continue perpetrating dependent identity fraud on governmental agencies, businesses, and innocent victims unless identity fraud detection and prevention mechanisms are available and in place. The disclosed technology provides a technical advancement in the field of dependent identity fraud detection, for example, by balancing the threats of dependent identity fraud with efficient service for legitimate requests for payments or benefits. Certain example implementations of the disclosed technology may be utilized to detect false positive situations and allow payment or benefit for scenarios that may otherwise be flagged as being suspicious. Thus, not only does the disclosed technology enable detecting identity fraud, it also can help prevent wasting of limited resources in the investigation of “false positive situations.”

The disclosed technology provides certain technical contributions that can enable the detection of anomalous activity related to dependent identity fraud. In certain example implementations, the improved computer systems disclosed may enable tracking and analysis of an entire population, such as the United States, and all related public or private data. The computation of such a massive amount of data, at the scale required to provide effective information, has been enabled by the improvements in computer processing speeds, memory utilization, and/or programming language as indicated herein. Those with ordinary skill in the art may recognize that traditional methods such as human activity, pen-and-paper analysis, or even traditional computation using general-purpose computers, are not sufficient to provide the level of data processing and anomaly detection, as disclosed, to provide the necessary speed and memory utilization while eliminating false-positives. The Applicant's disclosed technology provides technical improvements in computer processing that provides useful, tangible results that may have previously been unattainable.

In one example application of the disclosed technology, suspect or fraudulent tax returns refund requests may be detected. For example, the disclosed technology may utilize information supplied by the refundee together with information obtained from other sources, such as public or private databases, to determine if the refund request is likely to be fraudulent or legitimate. Various exemplary embodiments of the disclosed technology will now be described with reference to the accompanying figures.

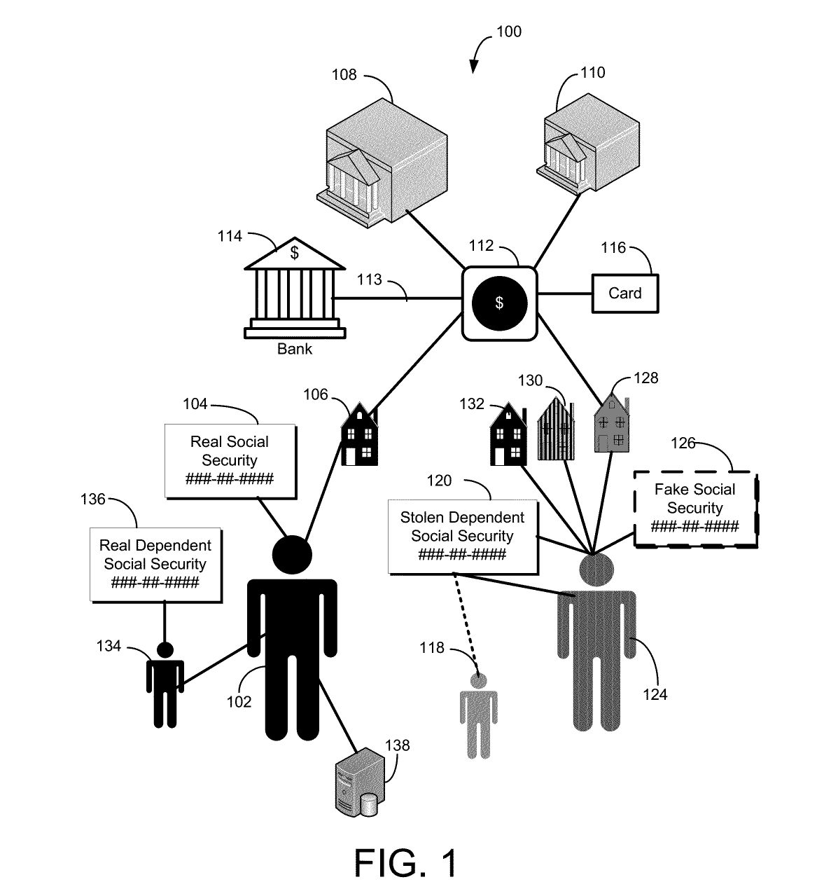

FIG. 1 shows a block diagram of an illustrative scenario associated with dependent identity theft, according to exemplary embodiments of the disclosed technology. In one example scenario, a legitimate entity 102 may have a record of activity with a commercial company 110 or governmental entity 108. For example, the activity may involve a tax return to the governmental entity 108, for example, the Internal Revenue Service (IRS) or a State Revenue Department.

In one example implementation, the legitimate entity 102 may have a legitimate social security number 104 associated with their name. In certain exemplary embodiments, the legitimate entity 102 may also have a legitimate address 106 associated with their name and/or social security number 104. In certain exemplary embodiments, the legitimate entity 102 may also have a legitimate dependent 134 having a real or legitimate social security number 136. According to certain exemplary embodiments, one or more databases 138 may be utilized, for example, to verify that the name, social security number 104, and/or address 106 postively match the identity of the legitimate entity 102.

In a typical normal scenario, the legitimate entity 102 may submit the request for payment or benefit, and governmental entity 108 may provide the payment or benefit 112. For example, the payment or benefit, in one example implementation may be a tax refund. Accordingly, in certain example implementation, the payment or benefit 112 may be dispersed to the legitimate entity 102 by one or more of: (1) a check mailed to the legitimate address 106; (2) a debit card 116 mailed to the legitimate address 106; or (3) electronic funds transferred 113 to the legitimate taxpayer's 102 bank account 114. In other example implementations, the payment or benefit 112 may dispersed or provided according to the normal procedures of the providing entity. In such a scenario, the system 100 may work quickly and efficiently to provide payment or service (for example a refund tax overpayment) to the legitimate entity 102.

Unfortunately, there exists other scenarios, as depicted in FIG. 1, where a fraudster 124 may apply for payment or benefit 112 using misrepresented or stolen identity information 120. In one exemplary scenario, the fraudster 124 may apply for payment or benefit 112 using a social security number 120 and name associated with another person's dependent 118. In certain scenarios, the fraudster 124 may open a bank account 114 in the name of the dependent 118 and request the payment or benefit 112 in the form of an electronic deposit 113. In another scenario, the fraudster 124 may request the payment or benefit 112 in the form of a debit card. Each of these scenarios may result in the fraudster 124 obtaining the payment or benefit 112 without having to present positive identification, for example, as is typically needed to cash a check.

In certain scenarios, the fraudster 124 may actually reside at a first address 132, or even in jail 130, but the fraudster 124 may submit a request for activity using a second address 128 to avoid being tracked down. In certain scenarios, the fraudster 124 may provide a fake or fabricated social security number 126 in requesting the payment or benefit. In yet another scenario, the fraudster 126 may steal the real social security number 136 associated with another person's 102 dependent 134 to obtain payment or benefit. Certain exemplary embodiments of the disclosed technology may be utilized to detect a potential fraudulent requests for payment or benefit, and may be utilized to cancel a payment or benefit to a potential fraudster 124. Certain embodiments of the disclosed technology may utilize social security number patterns, blocks, etc., and/or the age of the entity 102 124 to determine legitimacy of the request and/or the legitimacy of the requester's identity.

Various exemplary embodiments of the disclosed technology may be utilized to detect false positive situations and allow payment or benefit for scenarios that may otherwise be flagged as being suspicious. For example, a legitimate scenario that can appear as fraudulent involves taxable income from a first job. Typically, such taxpayers in this category may be minors with no public record associated with a residence or prior income. Due to the development of the Internet, technically well-informed fraudsters with sophisticated deception schemes are likely to continue perpetrating identity fraud on governmental agencies, businesses, and innocent victims unless identity fraud detection and prevention mechanisms are available and in place. The disclosed technology provides a technical advancement in the field of identity fraud detection, for example, by balancing the threats of identity fraud with efficient service for legitimate requests for payments or benefits. Thus, not only does the Applicant's disclosed technology enable detecting identity fraud, it also can help prevent wasting of limited resources in the investigation of false positive situations.

Because of the Internet, identity-theft fraudsters typically commit their crimes and move on well before the damage can be detected using traditional methods. The disclosed technology may utilize the Internet to combat a problem that is being perpetrated with the use of the Internet. The claimed solution is necessarily rooted in computer technology in order to overcome a problem specifically arising in the realm of computer networks.

According to certain exemplary embodiments of the disclosed technology, an entity 102 124 may provide certain PII information with a request for payment or benefit 112 that includes at least a name, social security number, and mailing address. In an exemplary embodiment, one or more databases 138 may be queried with the PII information. For example, the one or more databases 138 may include public or private databases. In accordance with certain exemplary embodiments, one or more public records may be utilized verify personally identifiable information (PII) or to retrieve additional information based on the PII. According to exemplary embodiments, the public records may include one or more of housing records, vehicular records, marriage records, divorce records, hospital records, death records, court records, property records, incarceration records, or utility records. In exemplary embodiments, the utility records can include one or more of utility hookups, disconnects, and associated service addresses.

According to exemplary embodiments, a plurality of independent information may be received in response to the querying of the public or private database(s). In accordance with exemplary embodiments, the independent information may include, but is not limited to (1) an indication of whether or not the entity is deceased; (2) independent address information associated with the entity; (3) address validity information associated with the PII information; (3) one or more public records associated with the PII information; or (4) no information.

Certain exemplary embodiments of the disclosed technology may make a comparison of the PII with the plurality of independent information to determine zero or more indicators of fraud. For example, embodiments of the disclosed technology may compare the PII information with the plurality of independent information to determine if the entity associated with the PII is associated with one or more records that have been indicated as being dependent-related. Such a scenario may represent a situation where a fraudster 124 has obtained a name and social security information 120 from a dependent 118 134, but where the address provided does not correspond with the known residence address 122 of the dependent 118 134, or with any known relatives or associates of the dependent 118 134. This scenario may be an indicator of an attempt by a fraudster 124 to have a dependent 118 134 payment or benefit 112 sent to a post office box or other address that can be monitored by the fraudster 124 without any direct tie to the fraudster 124. For example, a request for payment or benefit listing a person known to be 10 years old is very likely a fraudulent refund request.

According to another exemplary embodiment of the disclosed technology, a comparison may be made with the PII mailing address and the independent information to determine if the PII mailing address is invalid with no record of association between a zip code of the PII address and one or more zip codes associated with the independent address information. For example, situations exist where a legitimate entity 102 may abbreviate or include a typographical error their return mailing address, but they may provide a correct zip code that could be verified with the independent information. However, a fraudster 124 may be likely to use a completely different zip code, and in such situations, embodiments of the disclosed technology may utilize the inconsistent zip code information to flag a possible fraudulent tax return request.

According to another exemplary embodiment of the disclosed technology, a comparison may be made with the PII mailing address and the independent information to determine whether or not there is any record of association between the PII mailing address and any independent address information, such as the address of a relative, or associate. According to an exemplary embodiment, if there is no association between the PII mailing address and any independent address information, then there is a high likelihood that the activity is fraudulent.

In accordance with certain exemplary embodiments of the disclosed technology, fraud false positive indicators may determined, based at least in part on a comparison of the PII information with the plurality of independent information. Absent of exemplary embodiments of the disclosed technology, certain situations may be incorrectly flagged as fraudulent, and may create costly and unnecessary delays related to the disbursement of the activity. In one exemplary embodiment, a fraud false positive indicator may be based on an analysis to detect if the PII mailing address is invalid, but with a record of association between a zip code of the PII mailing address and one or more zip codes associated with the independent address information. This represents a situation where a legitimate entity 102 has abbreviated their address or included a typographical error in the address, but the zip code corresponds with one known to be associated with the legitimate entity 102.

According to another exemplary embodiment, a fraud false positive indicator may be based on the PII social security number when there is no independent information available. For example, in one exemplary embodiment, the PII social security number may be checked to determine if it is valid and issued within 3 to 15 years, and the independent information can be checked to see if it includes information. If no independent information is available and if the PII social security number is valid and issued within 3 to 15 years, then this information may provide an indication that the requesting entity is a dependent or a minor. In another exemplary embodiment, the social security number may be checked to determine if the entity is at least 24 years old with a valid social security number issued within 3 to 15 years, and the obtained independent information includes no information. In this scenario, exemplary embodiments of the disclosed technology may provide an indication that the requesting entity is an immigrant.

According to exemplary embodiments of the disclosed technology, one or more public or private databases 138 may be accessed to receive independent information. For example, one or more public records may be provide housing records, vehicular records, marriage records, divorce records, hospital records, death records, court records, property records, incarceration records, or utility records. In exemplary embodiments, the utility records may include one or more of utility hookups, disconnects, and associated service addresses. According to exemplary embodiments of the disclosed technology, such public records may be searched by social security number and/or name to provide independent information that can be utilized to verify PII information. For example, PII address information can be checked to determine if it corresponds to any addresses of relatives or associates of the entity.

According to certain exemplary embodiments of the disclosed technology, fraud associated with a request for activity may be detected by querying a Do Not Pay list with a combination of PII information and independent information obtained from one or more public records. For example, a person may be listed on a Do Not Pay list for a number of reasons, including being incarcerated, not paying dependent support, having liens, etc. Persons on the Do Not Pay list may supply an incorrect social security number or a slight misspelling of a name to avoid being matched with the information on the Do Not Pay list.

An example implementation of the disclosed technology may include receiving PII information that includes at least a name and a social security number and querying one or more public records with the PII information. Certain exemplary embodiments of the disclosed technology may receive, based at least on the querying, public data that includes one or more of a second social security number or variant of a social security number associated with PII name, a second name associated with the PII social security number, or a name variant associated with the PII social security number. For example, a variant may include information such as a name, a number, or an address, etc. that approximately matches real or legitimate information. A social security number variant, for example, may be nearly identical to a legitimate social security number, but with one or more numbers changed, transposed, etc.

According to exemplary embodiments of the disclosed technology, a Do Not Pay list may be queried with one or more combinations and/or variants of the PII information and the received public data, and a fraud alert may be output if the one or more combinations and/or variants result in a match with at least one record in the Do Not Pay list. Thus, in certain example implementations, the PII information may be compared with variations of information on the Do Not Pay list (and/or other public or private information) to determine a possible match. Conversely, in other example implementations, information obtained from the Do Not Pay list (and/or other public or private sources) may be compared with variations of the PII information to determine possible matches.

According to certain exemplary embodiments, the Do Not Pay list may be queried with one or more combinations of the PII name and PII social security number, the PII name and a second social security number or a variant of the social security number, the second name or name variant and the entity supplied social security number, or the second name or name variant and the second social security number or variant of the social security number. According to exemplary embodiments, if one of the combinations or variants matches the information on the Do Not Pay list, then a fraud alert may be output.

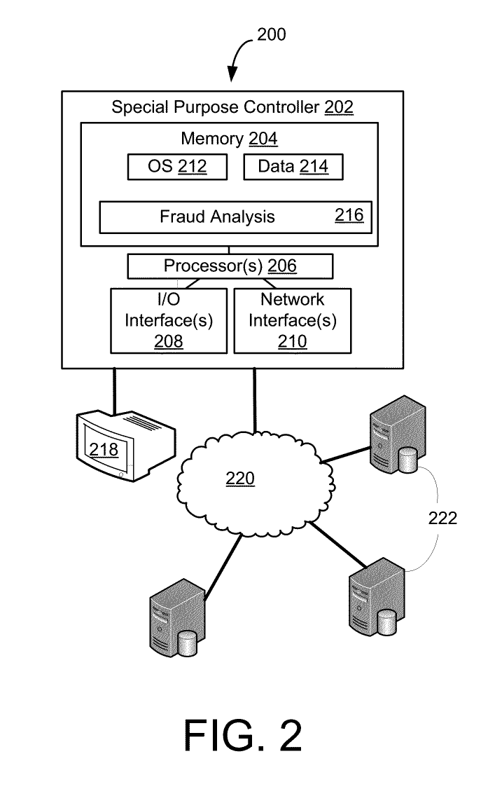

FIG. 2 depicts a block diagram of an illustrative fraud detection system 200 according to an exemplary embodiment of the disclosed technology. The system 200 includes a controller 202 that includes a memory 204, one or more processors 206, an input/out interface 208 for communicating with a local monitor 218 and input devices, and one or more network interfaces 210 for communicating with local or remote servers or databases 222, which may be accessed through a local area network or the internet 220. According to exemplary embodiments, the memory may included an operating system 212, data 214, and one or more fraud analysis modules 216.

As previously discussed, the disclosed technological improvement may utilize Internet technology to combat the issue of dependent-related identity fraud. Furthermore, certain example implementations of the disclosed technology provide tangible improvements in computer processing speeds, memory utilization, and/or programming languages to provide the meaningful step of determining, with one or more special-purpose computers having one or more computer processors in communication with a memory, based at least in part on a comparison of the entity-supplied information with at least a portion of the plurality of independent information, indicators of fraud.

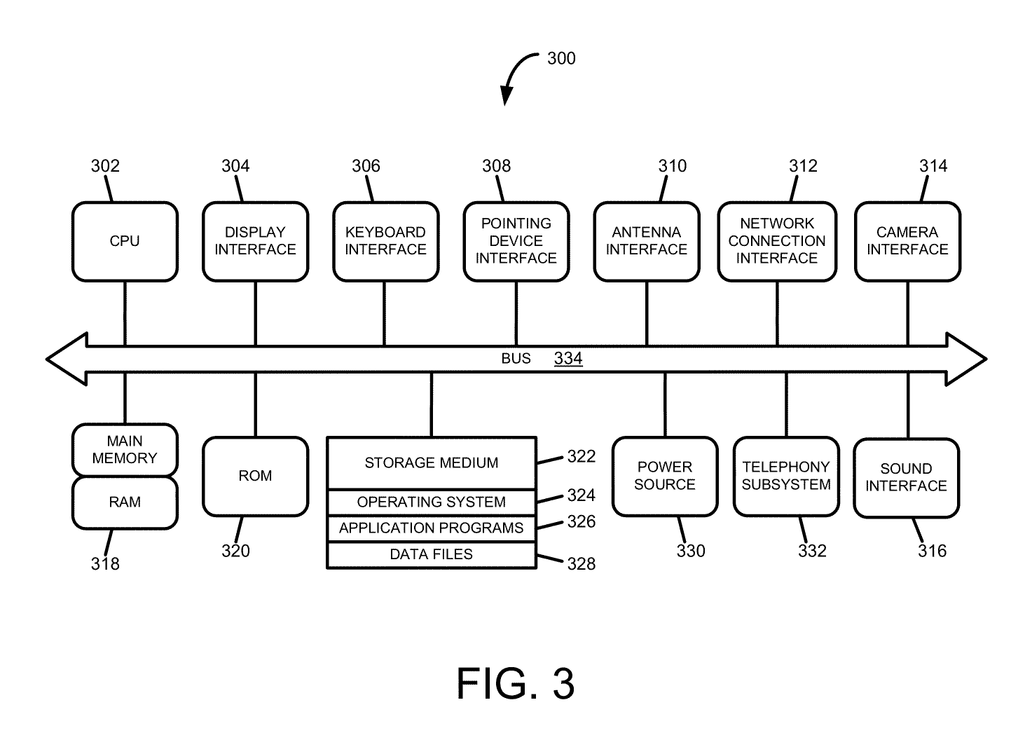

Various embodiments of the communication systems and methods herein may be embodied in non-transitory computer readable media for execution by a processor. An exemplary embodiment may be used in an application of a mobile computing device, such as a smartphone or tablet, but other computing devices may also be used. FIG. 3 illustrates schematic diagram of internal architecture of an exemplary mobile computing device 300. It will be understood that the architecture illustrated in FIG. 3 is provided for exemplary purposes only and does not limit the scope of the various embodiments of the communication systems and methods.

FIG. 3 depicts a block diagram of an illustrative computer system architecture 300 according to an exemplary embodiment of the disclosed technology. Certain aspects of FIG. 3 may also be embodied in the controller 202, as shown in FIG. 2. Various embodiments of the communication systems and methods herein may be embodied in non-transitory computer readable media for execution by a processor. It will be understood that the architecture illustrated in FIG. 3 is provided for exemplary purposes only and does not limit the scope of the various embodiments of the communication systems and methods.

The architecture 300 of FIG. 3 includes a central processing unit (CPU) 302, where computer instructions are processed; a display interface 304 that acts as a communication interface and provides functions for rendering video, graphics, images, and texts on the display; a keyboard interface 306 that provides a communication interface to a keyboard; and a pointing device interface 308 that provides a communication interface to a pointing device or touch screen. Exemplary embodiments of the architecture 300 may include an antenna interface 310 that provides a communication interface to an antenna; a network connection interface 312 that provides a communication interface to a network. In certain embodiments, a camera interface 314 is provided that acts as a communication interface and provides functions for capturing digital images from a camera. In certain embodiments, a sound interface 316 is provided as a communication interface for converting sound into electrical signals using a microphone and for converting electrical signals into sound using a speaker. According to exemplary embodiments, a random access memory (RAM) 318 is provided, where computer instructions and data are stored in a volatile memory device for processing by the CPU 302.

According to an exemplary embodiment, the architecture 300 includes a read-only memory (ROM) 320 where invariant low-level systems code or data for basic system functions such as basic input and output (I/O), startup, or reception of keystrokes from a keyboard are stored in a non-volatile memory device. According to an exemplary embodiment, the architecture 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, a widget or gadget engine, and or other applications, as necessary) and data files 328 are stored. According to an exemplary embodiment, the architecture 300 includes a power source 330 that provides an appropriate alternating current (AC) or direct current (DC) to power components. According to an exemplary embodiment, the architecture 300 includes and a telephony subsystem 332 that allows the device 300 to transmit and receive sound over a telephone network. The constituent devices and the CPU 302 communicate with each other over a bus 334.

In accordance with exemplary embodiments, the CPU 302 has appropriate structure to be a computer processor. In one arrangement, the computer CPU 302 is more than one processing unit. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Data is stored in the RAM 318, where the data is accessed by the computer CPU 302 during execution. In one exemplary configuration, the device 300 includes at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

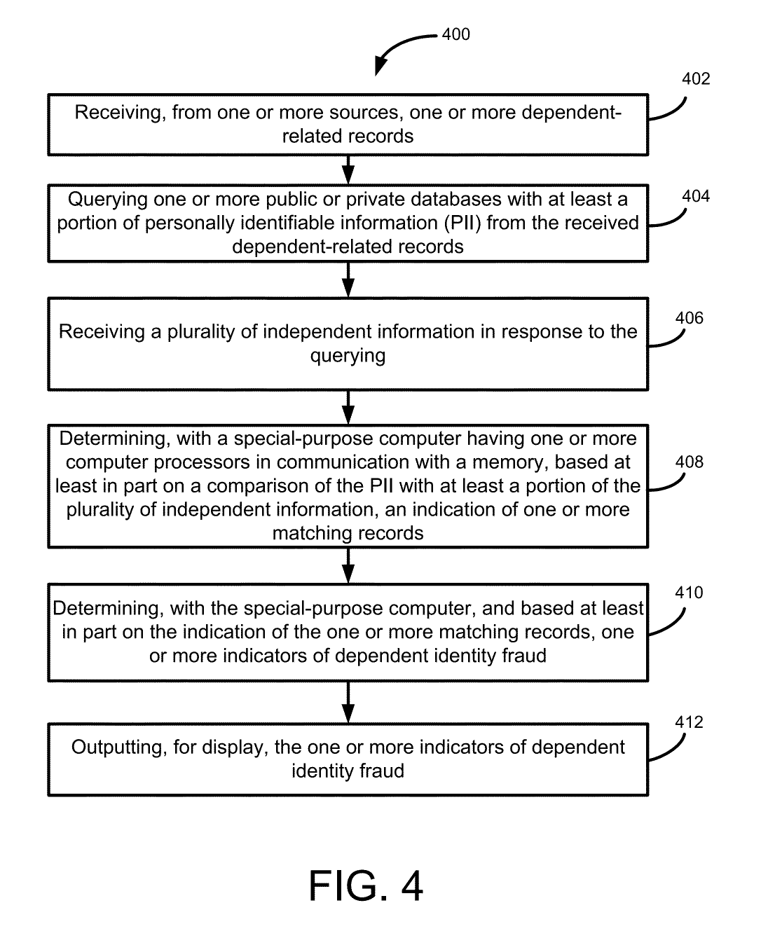

An exemplary method 400 will now be described with reference to the flowchart of FIG. 4 The method may be utilized to determine a likelihood of dependent identity misrepresentation, theft, and/or fraud. The method 400 starts in block 402, and according to an exemplary embodiment of the disclosed technology includes receiving, from one or more sources, one or more dependent-related records. In block 404, the method 400 includes querying one or more public or private databases with at least a portion of personally identifiable information (PII) from the received dependent-related records. In block 406, the method 400 includes receiving a plurality of independent information in response to the querying. In block 408, the method 400 includes determining, with one or more computer processors in communication with a memory, based at least in part on a comparison of the PII with at least a portion of the plurality of independent information, an indication of one or more matching records. In block 410, the method 400 includes determining, with one or more computer processors in communication with a memory, and based at least in part on the indication of the one or more matching records, one or more indicators of dependent identity fraud. In block 412, the method 400 includes outputting, for display, the one or more indicators of dependent identity fraud.

According to certain example embodiments, the plurality of independent information can include one or more of (1) an indication of whether or not the entity is a dependent; (2) independent address information associated with the entity; (3) address validity information associated with the PII information; (4) one or more records associated with the PII information; or (5) no information.

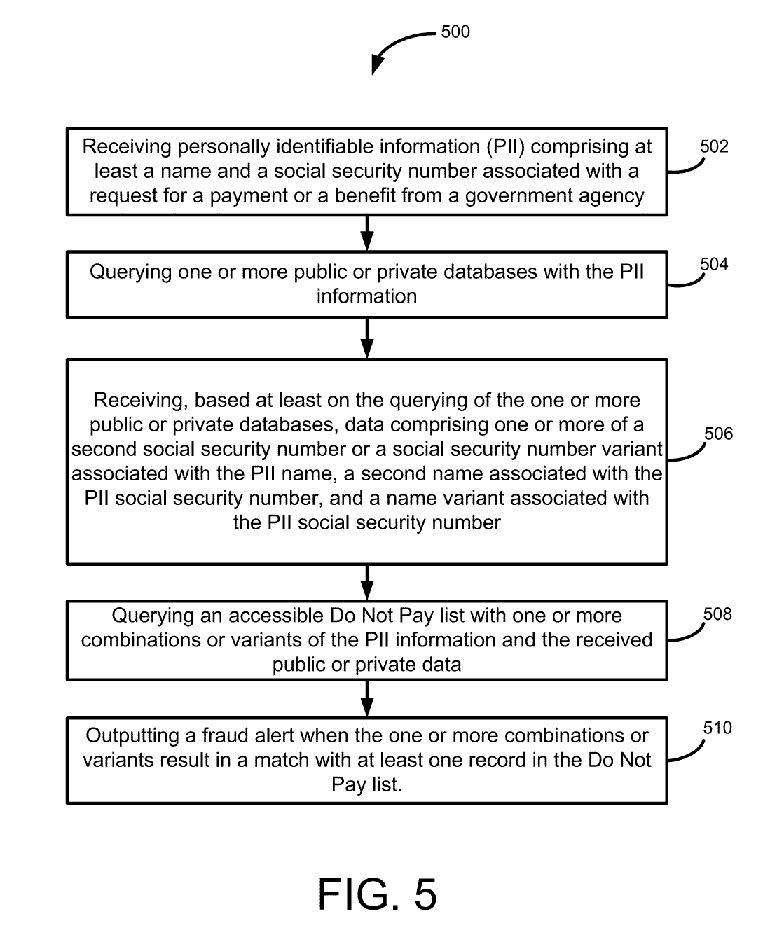

Another exemplary method 500 for detecting fraud related to dependent identity misrepresentation, dependent identity creation or dependent identity usurpation will now be described with reference to the flowchart of FIG. 5. The method 500 starts in block 502, and according to an exemplary embodiment of the disclosed technology includes receiving personally identifiable information (PII) comprising at least a name and a social security number associated with a request for a payment or a benefit from a government agency. In block 504, the method 500 includes querying one or more public or private databases with the PII information. In block 506, the method 500 includes receiving, based at least on the querying of the one or more public or private databases, data comprising one or more of a second social security number or a social security number variant associated with the PII name, a second name associated with the PII social security number, and a name variant associated with the PII social security number. In block 508, the method 500 includes querying an accessible Do Not Pay list with one or more combinations or variants of the PII information and the received public or private data. In block 510, the method 500 includes outputting a fraud alert when the one or more combinations or variants result in a match with at least one record in the Do Not Pay list.

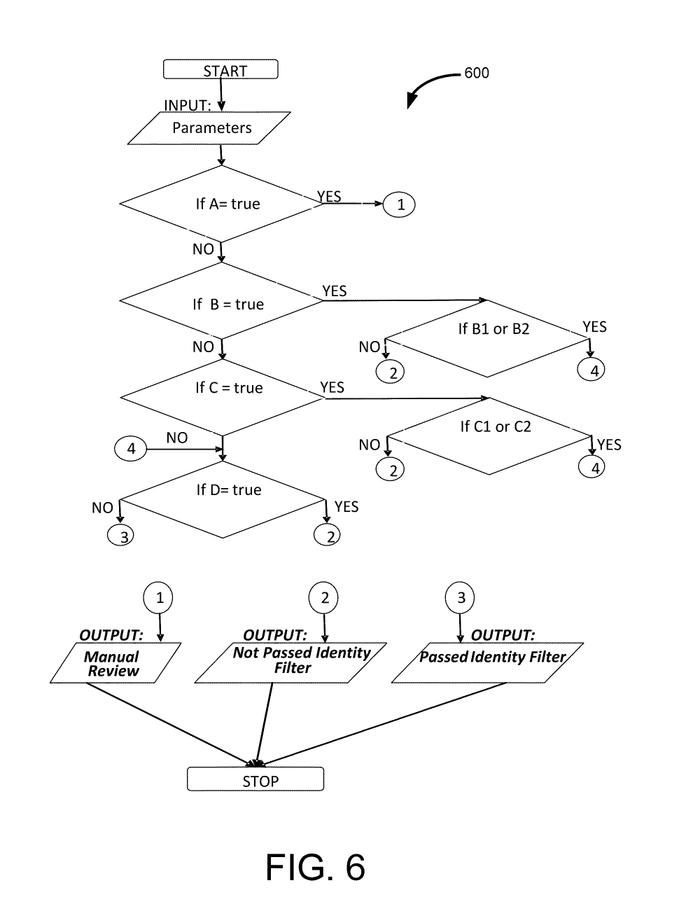

FIG. 6 depicts a flow diagram 600, according to an example process implementation. The flow diagram 600 may be utilized to test the input data, for example, so that a determination may be made, with a computer processor, as to whether or not the identity associated with and represented by the input data passes certain tests. For example, as shown in FIG. 6, input parameters and/or attributes associated with the input data may be tested based on a number of variables, scored, and sorted in to records that pass the identity filter tests, records that do not pass the identity filter tests, and records that may require manual review.

### Attribute Examples

Table 1 lists some of the attributes, descriptions, and example relative order of importance with respect to determining indicators of fraud, according to an example implementation of the disclosed technology. In accordance with certain example implementations, such attributes may be utilized for the various tests in conjunction with the flow diagram 600 as shown in FIG. 6. For example, the attribute VariationSearchAddrCount may be tested to see if it is associated with >2 addresses, and if so (and perhaps depending on other such tests with other attributes), the record may be flagged as not passing the identity filter test, and thus, may be an indicator of fraud.

TABLE 1

| Example | | |
|---|---|---|
| Order of | | |
| Importance | Attribute | Attribute Description |
| 1 | CorrelationSSNAddrCount | Total number of sources reporting input |
| | | SSN with input address |
| 2 | AssocDistanceClosest | Distance in miles between identity and |
| | | closest first-degree relative or associate |
| 3 | SearchUnverifiedAddrCountYear | Number of searches in the last year for |
| | | the identity using an address that was not |
| | | on the identity's file at the time of the |
| | | search |
| 4 | VariationSearchAddrCount | Total number of addresses associated |
| | | with the identity in searches |
| 5 | AddrChangeDistance | Distance in miles between input address |
| | | and the most recent unique address |
| 6 | IDVerRiskLevel | Indicates the fraud-risk level based on |
| | | how well the input components match |
| | | the information found for the input |
| | | identity |
| 6a | IDVerSSN | Indicates if the SSN is verified |
| 6b | IDVerName | Indicates if the identity's name is verified |
| 6c | IDVerAddress | Indicates if the input address is verified |
| 6d | IDVerPhone | Indicates if the input phone is verified |
| 7 | DivAddrSSNCount | Total number of unique SSNs currently |
| | | associated with input address |
| 8 | BankruptcyAge | Time since most recent bankruptcy filing |
| 9 | CorrelationSSNNameCount | Total number of sources reporting input |
| | | SSN with input name |
| 10 | PBProfile | Profile of purchase activity |
| 11 | VariationSearchSSNCount | Total number of SSNs associated with |
| | | the identity in searches |
| 12 | ValidationSSNProblems | Indicates SSN validation status— |
| | | Deceased |
| 13 | CriminalCount | Total criminal convictions |
| 14 | InputAddrNBRHDMultiFamilyCount | Total number of multi-family properties |
| | | in neighborhood |
| 14a | InputAddrNBRHDSingleFamilyCount | Total number of single family properties |
| | | in neighborhood |
| 14b | InputAddrNBRHDBusinessCount | Total number of businesses in |
| | | neighborhood |
| 15 | CurrAddrMedianIncome | Current address neighborhood median |
| | | income based on U.S. Census data |
| 16 | ValidationAddrProblems | Indicates input address validation status— |
| | | Invalid |
| 17 | SourceProperty | Indicates if identity is associated with the |
| | | ownership of real property |
| 18 | InputAddrDelivery | Indicates the delivery sequence status of |
| | | the input address—Vacant |
| 19 | SearchUnverifiedDOBCountYear | Number of searches in the last year for |
| | | the identity using a date of birth that was |
| | | not in the identity's record at the time of |
| | | search |
| 20 | ArrestAge | Time since most recent arrest |
| 21 | SourceEducation | Indicates if identity attended or is |
| | | attending college |
| 22 | InputAddrDwellType | Indicates input address dwelling type |
| 23 | AssocHighRiskTopologyCount | Total count of first-degree relatives or |
| | | associates that are reported from high |
| | | risk sources |
| 24 | SourceAs sets | Indicates if identity is associated with the |
| | | ownership of assets (vehicles, watercraft, |
| | | and aircraft) |
| 25 | ValidationSSNProblems | Indicates SSN validation status—Invalid |
| 26 | SourcePhoneDirectoryAssistance | Indicates if identity has a phone listing in |
| | | Electronic Directory Assistance (EDA) |

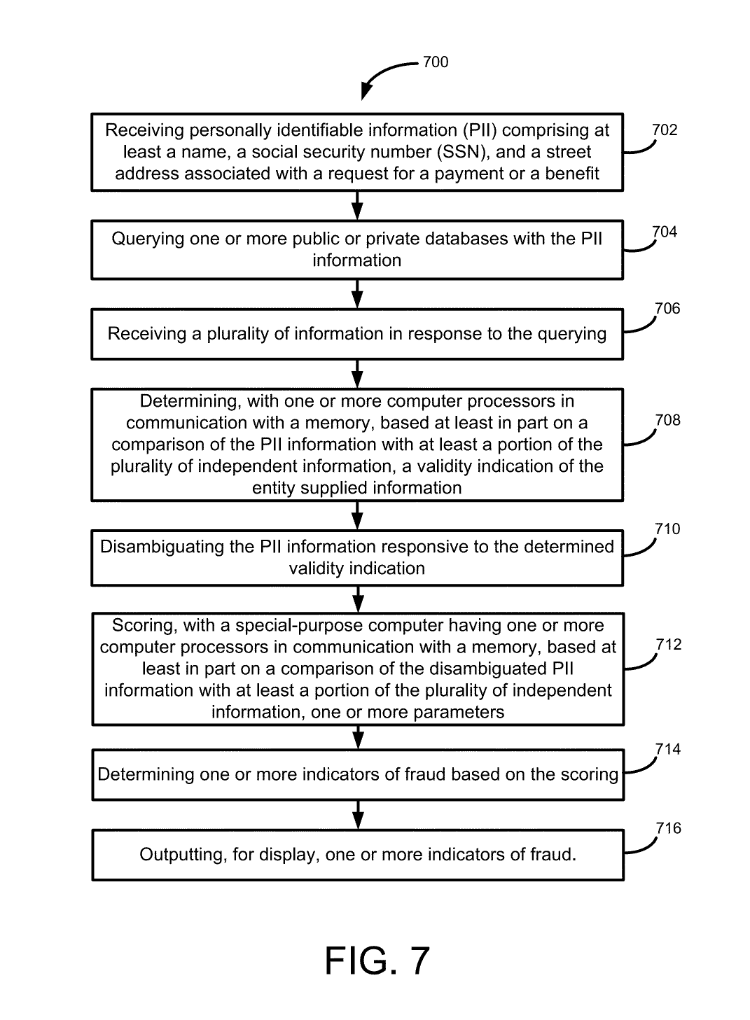

An exemplary method 700 for disambiguating input information and determining a likelihood of dependent identity-related fraud will now be described with reference to the flowchart of FIG. 7. The method 700 starts in block 702, and according to an exemplary embodiment of the disclosed technology includes receiving personally identifiable information (PII) comprising at least a name, a social security number (SSN), and a street address associated with a request for a payment or a benefit. In block 704, the method 700 includes querying one or more public or private databases with the PII information. In block 706, the method 700 includes receiving a plurality of information in response to the querying. In block 708, the method 700 includes determining, with one or more computer processors in communication with a memory, based at least in part on a comparison of the PII information with at least a portion of the plurality of independent information, a validity indication of the entity supplied information. In block 710, the method 700 includes disambiguating the PII information responsive to the determined validity indication. In block 712, the method 700 includes scoring, with one or more computer processors in communication with a memory, based at least in part on a comparison of the disambiguated PII information with at least a portion of the plurality of independent information, one or more parameters. In block 714, the method 700 includes determining one or more indicators of fraud based on the scoring. In block 716, the method 700 includes outputting, for display, one or more indicators of fraud.

According to an example implementation, the one or more parameters may include, but are not limited to: a distance between the PII street address and a street address of one or more entity relatives or entity associates; a number of records associating the PII SSN and the PII street address; a number of unique SSNs associated with the PII street address; a number sources reporting the PII SSN with the PII name; and/or the number of other entities associated with the PII SSN.

Certain example implementations further include scoring neighborhood fraud metrics based on the PII street address based on one or more of: presence of businesses in the surrounding neighborhood, density of housing in the neighborhood; and median income in the neighborhood.

In an example implementation, determining the validity indication of the entity supplied or PII information further includes determining one or more of: whether entity is a dependent, whether the entity is or has been incarceration record (currently incarcerated, has had prior incarceration, and time since incarceration), whether the entity has been involved in a bankruptcy, and whether the PII address is included in public record.

According to an example implementation, the plurality of independent information includes, as applicable: an indication of whether or not the entity is a dependent, and an age of the dependent; independent address information associated with the entity; address validity information associated with the PII information; one or more records associated with the PII information; or no information.

In certain example implementations of the disclosed technology, receiving the plurality of independent information includes receiving the one or more records comprising one or more of housing records, vehicular records, marriage records, divorce records, hospital records, death records, court records, property records, incarceration records, tax records, and utility records, wherein the utility records comprise one or more of utility hookups, disconnects, and associated service addresses.

In certain example implementations of the disclosed technology, receiving the independent address information or the address validity information includes receiving one or more addresses of relatives or associates of the entity.

In an example implementation, the one or more public or private databases are independent of the government agency.

In an example implementation, receiving the PII information includes receiving the name, social security number (SSN), and street address associated with a request for a payment or a benefit from a government agency.

According to exemplary embodiments, certain technical effects are provided, such as creating certain systems and methods that detect fraud related to dependent identity theft. Exemplary embodiments of the disclosed technology can provide the further technical effects of providing systems and methods for determining and eliminating false positives with respect to fraud. Certain example embodiments include technical effects of providing systems and methods for disambiguating input information, resulting in higher quality determinations of fraudulent activities.

In exemplary embodiments of the disclosed technology, the dependent-related identity fraud detection system 200 and/or the system architecture 300 may include any number of hardware and/or software applications that are executed to facilitate any of the operations. In exemplary embodiments, one or more I/O interfaces may facilitate communication between the fraud detection system 200 and/or the fraud detection system architecture 300 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the fraud detection system 200 and/or the fraud detection system architecture 300. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of the fraud detection system 200 and/or the fraud detection system architecture 300 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ enabled network, a Wi-Fi™ enabled network, a satellite-based network any wired network, any wireless network, etc., for communication with external devices and/or systems.

As desired, embodiments of the disclosed technology may include the fraud detection system 200 and/or the fraud detection system architecture 300 with more or less of the components illustrated in FIG. 2 and FIG. 3.

Certain embodiments of the disclosed technology are described above with reference to block and flow diagrams of systems and methods and/or computer program products according to exemplary embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method for determining a likelihood of identity fraud associated with a dependent, comprising:
receiving, from one or more sources, one or more dependent-related records;
querying one or more public or private databases with at least a portion of personally identifiable information (PII) from the received dependent-related records;
receiving a plurality of independent information in response to the querying;
determining, with a special-purpose computer having one or more computer processors in communication with a memory, based at least in part on a comparison of the PII with at least a portion of the plurality of independent information, an indication of one or more matching records;
determining, with the special-purpose computer, and based at least in part on the indication of the one or more matching records, one or more indicators of dependent identity fraud; and
outputting, for display, the one or more indicators of the dependent identity fraud.

2. The method of claim 1, wherein the one or more indicators of dependent identity fraud are determined responsive to the received independent information being related to a real estate purchase corresponding to the PII.

3. The method of claim 1, wherein the one or more indicators of dependent identity fraud are determined responsive to the received independent information being related to an application for credit corresponding to the PII.

4. The method of claim 1, wherein one or more indicators of dependent identity fraud are determined responsive to the received independent information being related to an adult tax filer corresponding to the PII.

5. The method of claim 1, further comprising:
determining, from available records, which identities associated with the one or more dependent-related records are claimed as dependents;
based on the PII from these identities, searching or more public or private databases to determine others who are using the same identities; and
determining, with the special-purpose computer, one or more indicators of dependent identity fraud when the number of others who are using the same identity exceeds a threshold.

6. The method of claim 1, further comprising utilizing a model to build a profile of indicators of fraud based on multiple variables, wherein the model is utilized to produce one or more scores indicating the likelihood or probability of fraud associated with dependent identity theft.

7. The method of claim 1, further comprising:
determining address information associated with the PII;
determining addresses of closest relatives or associates associated with the PII;
determining distances between the addresses; and
determining one or more indicators of dependent identity fraud based on the distances.

8. The method of claim 1, further comprising determining one or more indicators of dependent identity fraud based on one or more neighborhood characteristics of address information associated with the PII.

9. The method of claim 1, further comprising determining a validity of the one or more dependent-related records to verify whether the one or more dependent-related records corresponds to a real identity.

10. The method of claim 1, wherein receiving the plurality of independent information comprises receiving one or more of housing records, vehicular records, marriage records, divorce records, hospital records, death records, court records, property records, incarceration records, tax records, and utility records, wherein the utility records comprise one or more of utility hookups, disconnects, and associated service addresses.

11. A system comprising:
a special-purpose computer, comprising at least one memory for storing data and computer-executable instructions, and at least one processor configured to access the at least one memory and further configured to execute the computer-executable instructions to:
receive, from one or more sources, one or more dependent-related records;
query one or more public or private databases with at least a portion of personally identifiable information (PII) from the received dependent-related records;
receive a plurality of independent information in response to the querying;
determine, based at least in part on a comparison of the PII with at least a portion of the plurality of independent information, an indication of one or more matching records;
determine, based at least in part on the indication of the one or more matching records, one or more indicators of dependent identity fraud; and
output, for display, the one or more indicators of the dependent identity fraud.

12. The system of claim 11, wherein the at least one processor is further configured to execute the computer-executable instructions to determine the one or more indicators of dependent identity fraud responsive to the received independent information being related to a real estate purchase corresponding to the PII.

13. The system of claim 11, wherein the at least one processor is further configured to execute the computer-executable instructions to determine the one or more indicators of dependent identity fraud responsive to the received independent information being related to an application for credit corresponding to the PII.

14. The system of claim 11, wherein the at least one processor is further configured to execute the computer-executable instructions to determine the one or more indicators of dependent identity fraud responsive to the received independent information being related to an adult tax filer corresponding to the PII.

15. The system of claim 11, wherein the at least one processor is further configured to execute the computer-executable instructions to:
determine, from available records, which identities associated with the one or more dependent-related records are claimed as dependents;
search, based on the PII from these identities, or more public or private databases to determine others who are using the same identities; and
determine one or more indicators of dependent identity fraud when the number of others who are using the same identity exceeds a threshold.

16. The system of claim 11, wherein the at least one processor is further configured to execute the computer-executable instructions to utilize a model to build a profile of indicators of fraud based on multiple variables, wherein the model is utilized to produce one or more scores indicating the likelihood or probability of fraud associated with dependent identity theft.

17. The system of claim 11, wherein the at least one processor is further configured to:
determine address information associated with the PII;
determine addresses of closest relatives or associates associated with the PII;
determine distances between the addresses; and
determine one or more indicators of dependent identity fraud based on the distances.

18. The system of claim 11, wherein the at least one processor is further configured to determine one or more indicators of dependent identity fraud based on one or more neighborhood characteristics of address information associated with the PII.

19. The system of claim 11, wherein the at least one processor is further configured to determine a validity of the one or more dependent-related records to verify whether the one or more dependent-related records corresponds to a real identity.

20. The system of claim 11, wherein the plurality of independent information comprises one or more of housing records, vehicular records, marriage records, divorce records, hospital records, death records, court records, property records, incarceration records, tax records, and utility records, wherein the utility records comprise one or more of utility hookups, disconnects, and associated service addresses.
